(19) United States
(12) Patent Application Publication
(10) Pub. No.: US 2014/0143128 A1
(43) Pub. Date: May 22, 2014

(54) UNSECURED TO SECURED LOAN CONVERSION IN AUTOMOBILE FINANCE

(71) Applicants: Luke A. Hammock, Washington, DC (US); Janusz Michael Niczyporuk, Vienna, VA (US)

(72) Inventors: Luke A. Hammock, Washington, DC (US); Janusz Michael Niczyporuk, Vienna, VA (US)

(73) Assignee: Capital One Financial Corporation, McLean, VA (US)

(21) Appl. No.: 14/042,379

(22) Filed: Sep. 30, 2013

Related U.S. Application Data
(60) Provisional application No. 61/727,499, filed on Nov. 16, 2012.

(51) Int. Cl. G06Q 40/02

(52) U.S. Cl. CPC G06Q 40/025
USPC 705/38

(57) ABSTRACT

Systems and methods are disclosed for configuring a loan account program to provide buyers of items, particularly automobiles, the full principal of the loan directly into a financial service account. A financial service system receives a request for a loan from a buyer. Following a risk assessment check, the financial service system configures an unsecured loan product for the buyer and transfers the entire financed principal into a financial service account associated with the buyer. Upon confirmation of the purchase and/or satisfaction of other criteria, the buyer's loan account may be converted to a secured loan account product with more favorable terms.

### CROSS REFERENCE TO RELATED APPLICATION

This application claims priority under 35 U.S.C. §119 to U.S. Provisional Application No. 61/727,499, filed on Nov. 16, 2012, which is expressly incorporated herein by reference in its entirety.

### FIELD

The disclosed embodiments generally relate to financing sales of goods or services, in particular increasing the rate of conversion from customers approved for loans to customers who actually consummate the loans.

### BACKGROUND

Advances in the financial and information technology industries have transformed the way items, such as automobiles, are bought and sold. In the past, for example, virtually every car was purchased when a prospective buyer ventured onto the lot of the local car dealership and sought financing from the dealer. Today, cars are sold through digital channels and can be financed prior to car purchase using digital channels; as a result dealers and the financial institutions that provide financing must make the process of purchasing a car and financing the purchase much quicker and more flexible.

Today, prospective buyers may shop around and even apply for automobile loans from a number of financial institutions before accepting an offer from one of them to finance their purchase. While convenient for the buyer and the seller, this process can create uncertainty for the financial institutions that go to great lengths to provide timely and accurate responses to potential customers. Of the multitude of loan offers that prospective buyers might “accept” during the shopping process, only a fraction are converted into actual loans for the financial institution.

The auto financing process can be time-consuming and stressful for all parties involved. Buyers may need to wait days or even weeks confirming the value, legitimacy, and condition of the car they are purchasing in order to receive funds. Additionally, conditions may force buyers to haggle for financing with the very entity selling them the car, who may not have the buyer's interests at heart.

Accordingly, there is a need to reform the auto financing process to provide more speed and certainty to the process for all parties involved—the buyer, the seller, and the financing institution.

### SUMMARY

Methods and systems consistent with the present disclosure enable a computing system to receive an indication that a buyer has requested a loan account, with the indication including buyer information. The computing system may determine the creditworthiness of the buyer based on the buyer information, and configure a loan account according to a first set of terms for the buyer based on the creditworthiness determination. Additionally, the computer system may initiate transmission of funds associated with the account to the buyer according to the first set of terms. Subsequent to the transmission of funds, the computing system may receive purchase transaction information associated with a sale of a buyer item. Further, the computing system may determine an eligibility score for a secured loan account associated with the buyer based on the buyer information and received purchase information, and may associate a second set of terms for the loan account based on the determined eligibility score.

In another embodiment, a method is disclosed for providing purchase financing. The method includes receiving an indication that a buyer has requested a loan account, with the indication including buyer information. Further, the method includes determining, via one or more processors, the creditworthiness of the buyer based on the buyer information. Based on the determination, the method includes configuring, via the one or more processors, a loan account according to a first set of terms for the buyer based on the creditworthiness determination, and initiating transmission of funds to the buyer according to the first set of terms. Additionally, the method includes receiving purchase transaction information associated with the sale of an item purchased by the buyer subsequent to the transmission of funds. Further, the method includes determining an eligibility score for a secured loan account associated with the buyer based on the buyer information and received purchase information, and associating a second set of terms for the loan account based on the determined eligibility score.

In yet another embodiment, a system is disclosed for providing purchase financing. The system is configured to receive an indication that a buyer wishes to commence a purchase transaction, the indication including buyer information. The system is further configured to transmit information associated with one or more of the buyer or the purchase transaction to a financial service system, and receive confirmation of buyer financing eligibility for an unsecured loan account associated with the purchase transaction from the financial service system. Additionally, the system is configured to transmit purchase transaction information associated with the sale of a buyer item to the financial service system, and receive funds associated with the unsecured loan account comprising the financed portion of the sales price from the buyer, wherein the funds were transmitted to a financial service account associated with the buyer by the financial service system.

Additional objects and advantages of the disclosed embodiments will be set forth in part in the description which follows, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed. For example, the methods relating to the disclosed embodiments may be implemented in system environments outside of the exemplary system environments disclosed herein.

### BRIEF DESCRIPTION OF THE DRAWINGS

The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 illustrates an exemplary system consistent with disclosed embodiments;

FIG. 2 is a flowchart of an exemplary unsecured loan initiation process consistent with disclosed embodiments;

FIG. 3 is a flowchart of an exemplary loan account conversion process consistent with disclosed embodiments; and

FIG. 4 is a flowchart of an exemplary dealer loan initiation process consistent with disclosed embodiments.

### DETAILED DESCRIPTION

Reference will now be made in detail to disclosed embodiments, examples of which are illustrated in the accompanying drawings. Wherever convenient, the same reference numbers will be used throughout the drawings to refer to the same or like parts.

Generally, the disclosed embodiments are directed to systems and methods for improving capture rate of loan offers by providing buyers of items funds up front in an unsecured loan product, then converting the loan to a conventional secured loan once certain criteria are met. For ease of discussion, embodiments may be described in connection with the sale of automobiles. It is to be understood, however, that disclosed embodiments are not limited to the sale of automobiles and may, in fact, be applied to the sale, auctioning, etc. of any item, product, or service. Further, steps or processes disclosed herein are not limited to being performed in the order described, but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments or they may include a general purpose computer or computing platform selectively activated or reconfigured by program code to provide the necessary functionality. The processes disclosed herein may be implemented by a suitable combination of hardware, software, and/or firmware. For example, the disclosed embodiments may implement general purpose machines that may be configured to execute software programs that perform processes consistent with the disclosed embodiments. Alternatively, the disclosed embodiments may implement a specialized apparatus or system configured to execute software programs that perform processes consistent with the disclosed embodiments.

The disclosed embodiments also relate to tangible and non-transitory computer readable media that include program instructions or program code that, when executed by one or more processors, perform one or more computer-implemented operations. For example, the disclosed embodiments may execute high level and/or low level software instructions, such as machine code (e.g., such as that produced by a compiler) and/or high level code that can be executed by a processor using an interpreter.

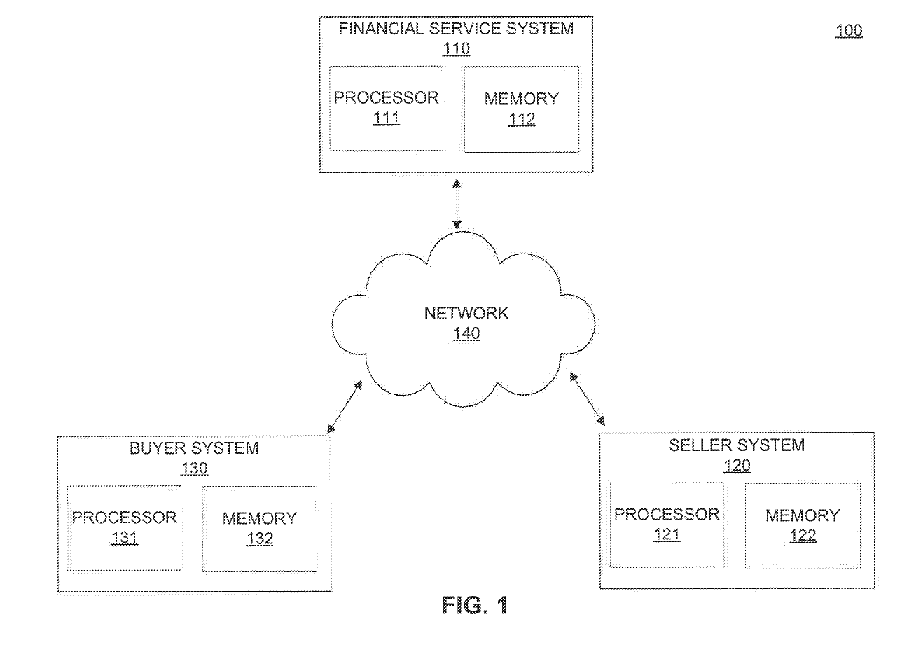

FIG. 1 illustrates an exemplary system 100 consistent with disclosed embodiments. In one aspect, system 100 may include a financial service system 110, seller system 120, buyer system 130, and network 140.

Financial service system 110 may be one or more entities that configure, offer, provide, and/or manage financial service accounts, such as credit card accounts, debit card accounts, checking or savings accounts, and loan accounts. Consistent with the disclosure, financial service system 110 may provide a loan account for financing a purchase to one or more consumers, such as buyer system 130. In some embodiments, financial service system 110 may receive and process payments from consumers associated with, for example, buyer system 130, relating to provided financial service accounts. Financial service system 110 may also process other funds and payments related to a sale, such as transmitting funds comprising the sales price of the item or service to buyer system 130.

Financial service system 110 may include one or more components that perform processes consistent with the disclosed embodiments. For example, financial service system 110 may include one or more computers (e.g., servers, database systems, etc.) configured to execute software instructions programmed to perform aspects of the disclosed embodiments, such as generating financial service accounts and/or loan accounts, maintaining accounts, processing information relating to accounts, etc. Consistent with disclosed embodiments, financial service system 110 may include other components and infrastructure that enable it to perform operations, processes, and services consistent with financial service account providers, such as banking operations, credit card operations, loan operations, etc. Consistent with disclosed embodiments, financial service system 110 may be configured to provide, manage, monitor, and assess a financing program comprising an initial offer of an unsecured loan product, later converted to a secured loan product, for a sales transaction between two private parties.

Seller system 120 may represent an entity seeking to sell an item to another party. Although the following description of disclosed embodiments may refer to an “individual,” one skilled in the art would appreciate that the same description applies to multiple sellers acting in concert or to a seller entity in the manner described above.

Seller system 120 may include components and infrastructure that enable it to perform operations, processes, and services consistent with merchants, such as providing websites that offer for sale goods and/or services, processing sales transactions of purchases made over the Internet or at POS locations, and communicating with financial service system 110 or other components relating to the transactions. Consistent with disclosed embodiments, seller system 120 may be configured to sell an item to a buyer, process the sales transaction, and communicate with a financial service account provider.

Buyer system 130 may represent an entity seeking to buy an item from another party. Although the following description of disclosed embodiments may refer to an “individual,” one skilled in the art would appreciate that the same description applies to multiple sellers acting in concert or to a seller entity in the manner described above.

Buyer system 130 may include one or more components that perform processes consistent with the disclosed embodiments. For example, buyer system 130 may include one or more computers (e.g., servers, database systems, etc.) that are configured to execute software instructions programmed to perform aspects of the disclosed embodiments. One of ordinary skill in the art would recognize that buyer system 130 may include components and infrastructure that enable it to perform operations, processes, and services, such as processing sales transactions of purchases made over the Internet or at POS locations, and communicating with financial service system 110 or other components relating to the transactions. Consistent with disclosed embodiments, buyer system 130 may be configured to purchase an item, transmit and receive information associated with the purchase transaction, and process and monitor a loan account associated with financing the purchase transaction.

Consistent with disclosed embodiments, components of system 100, including financial service system 110, seller system 120, and buyer system 130, may include one or more processors (such as processors 111, 121, or 131) as shown in exemplary form in FIG. 1. The processors may be one or more known processing devices, such as a microprocessor from the Pentium™ family manufactured by Intel™ or the Turion™ family manufactured by AMD™. The processor may include a single core or multiple core processor system that provides the ability to perform parallel processes simultaneously. For example, the processors may be single core processors configured with virtual processing technologies known to those skilled in the art. In certain embodiments, the processors may use logical processors to simultaneously execute and control multiple processes. The processors may implement virtual machine technologies, or other similar known technologies to provide the ability to execute, control, run, manipulate, store, etc. multiple software processes, applications, programs, etc. In some embodiments, the processors may include a multiple-core processor arrangements (e.g., dual or quad core) configured to provide parallel processing functionalities to enable computer components of financial service system 110, seller system 120, and/or buyer system 130 to execute multiple processes simultaneously. Other types of processor arrangements could be implemented that provide for the capabilities disclosed herein. Moreover, the processors may represent one or more servers or other computing devices that are associated with financial service system 110, seller system 120, and/or buyer system 130. For instance, the processors may represent a distributed network of processors configured to operate together over a local or wide area network. Alternatively, the processors may be a processing device configured to execute software instructions that receive and send information, instructions, etc. to/from other processing devices associated with financial service system 110 or other components of system 100. In certain aspects, processors 111, 121, and/or 131 may be configured to execute software instructions stored in memory to perform one or more processes consistent with disclosed embodiments.

Consistent with disclosed embodiments, components of system 100, including financial service system 110, seller system 120, and buyer system 130, may also include one or more memory devices (such as memories 112, 122, and 132) as shown in exemplary form in FIG. 1. The memory devices may store software instructions that are executed by processors 111, 121, and/or 131, such as instructions associated with one or more applications, network communication processes, operating system software, software instructions relating to the disclosed embodiments, and any other type of application or software known to be executable by processing devices. The memory devices may be volatile or non-volatile, magnetic, semiconductor, tape, optical, removable, nonremovable, or other types of storage devices or tangible computer-readable media. The memory devices may be two or more memory devices distributed over a local or wide area network, or may be a single memory device. In disclosed embodiments, the memory devices may include database systems, such as database storage devices, configured to receive instructions to access, process, and send information stored in the storage devices.

In some embodiments, financial service system 110, seller system 120, and buyer system 130 may also include one or more additional components (not shown) that provide communications with other components of system environment 100, such as through network 140, or any other suitable communications infrastructure.

Network 140 may be any type of network that facilitates communications and data transfer between components of system environment 100, such as, for example, financial service system 110, seller system 120, and buyer system 130. Network 140 may be a Local Area Network (LAN), a Wide Area Network (WAN), such as the Internet, and may be a single network or a combination of networks. Further, network 140 may reflect a single type of network or a combination of different types of networks, such as the Internet and public exchange networks for wireline and/or wireless communications. Network 140 may utilize cloud computing technologies. Moreover, any part of network 140 may be implemented through infrastructures or channels of trade to permit operations associated with financial accounts that are performed manually or in-person by the various entities illustrated in FIG. 1. Network 140 is not limited to the above examples and system 100 may implement any type of network that allows the entities (and others not shown) included in FIG. 1 to exchange data and information.

Although FIG. 1 describes a certain number of entities and processing/computing components within system 100, any number or combination of components may be implemented without departing from the scope of the disclosed embodiments. For example, different seller systems 120 may interact with one or more buyer systems 130 through network 140 or standard channels of trade, such as face-to-face purchase transactions. In another example, different financial service systems 110 may interact with one or more seller systems 120 and buyer systems 130 through network 140 or standard channels of trade. Additionally, financial service system 110, seller system 120, and buyer system 130 are not mutually exclusive. For example, in one disclosed embodiment, financial service system 110 and seller system 120 may be the same entity. Thus, the entities as described are not limited to their discrete descriptions above. Further, where different components of system environment 100 are combined (e.g., financial service system 110 and seller system 120, etc.), the computing and processing devices and software executed by these components may be integrated into a local or distributed system.

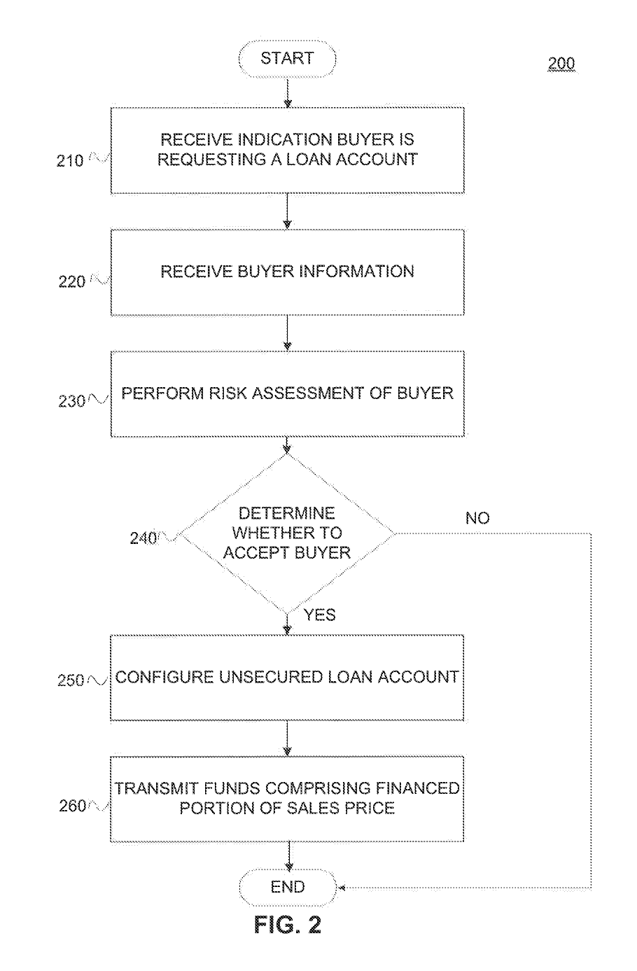

FIG. 2 illustrates an exemplary unsecured loan initiation process consistent with disclosed embodiments. Unsecured loan initiation process 200, as well as any or all of the individual steps therein, may be performed by any one or more of financial service system 110, seller system 120, or buyer system 130. For exemplary purposes, FIG. 2 is disclosed as being performed by financial service system 110.

Financial service system 110 may receive an indication that a buyer is requesting a loan account (Step 210). For exemplary purposes, the buyer is buyer system 130. In one aspect, financial service system 110 may receive the indication from seller system 120 sent on behalf of buyer system 130. In one aspect, financial service system 110 may receive the indication through a website or other internet portal via network 140 set up for such a purpose. In another aspect, financial service system 110 may receive the indication via a mobile application. In another aspect, financial service system 110 may receive the indication via an electronic message. It is understood that these examples are not intended to be limiting, and that financial service system 110 may receive the indication from buyer system 130 via any number of methods of communication.

Financial service system 110 may receive information about the user or users associated with buyer system 130 via network 140 (Step 220). The information gathered may include name, address, social security or other government ID number, credit history, employment information, financial history, information about the item proposed to be purchased, and financial service account information, but this list is not intended to be limiting and any particular encounter may prompt receipt of more or less information.

Financial service system 110 may process or receive information regarding a risk assessment or other similar credit worthiness analysis of the user or users of buyer system 130 based on the information received from buyer system 130 (Step 230).

Financial service system 110 may use the information received from buyer system 130, the results of the risk assessment of Step 230, and other predefined criteria to determine whether or not to offer an unsecured loan product to the user of buyer system 130 (Step 240). Financial service system 110 may decide not to accept the prospective seller into the program (Step 240; NO), and if so, the buyer may finance the purchase through other conventional means.

Financial service system 110 may alternatively decide to offer the unsecured loan product to the user of buyer system 130 (Step 240; YES). Financial service system 110 may configure an unsecured loan account for buyer system 130 (Step 250). Financial service system 110 may set parameters of the loan account such as interest rate, payment schedule, and loan principal based on the information received in Steps 220-230. The unsecured loan may or may not have collateral attached to the loan account.

Financial service system 110 may initiate the transmission of funds comprising the entirety of the loan amount into a financial service account associated with buyer system 130 (Step 260). In one aspect, the financial service account may be an existing account associated with buyer system 130 held by financial service system 110. In another aspect, financial service system 110 may configure a new financial service account for buyer system 130 and transmit the funds directly into the new account. In another aspect, the financial service account may be unaffiliated with financial service system 110. In another aspect, the financial service account may be affiliated with seller system 120, and financial service system 110 may therefore pay the purchase cost for the item directly rather than paying buyer system 130 first. In one aspect, financial service system 110 may transmit the funds directly to buyer system 130 via wire transfer. In another aspect, the funds may be transferred via postal mail or other direct delivery service as a check, cashier's check, or money order.

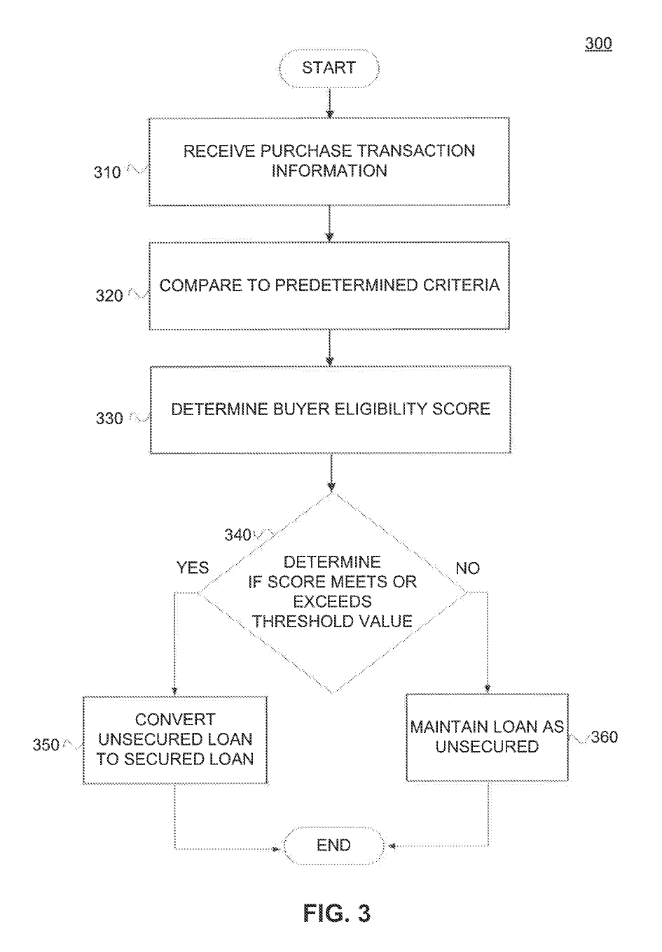

FIG. 3 illustrates an exemplary loan account conversion process, consistent with disclosed embodiments. Loan account conversion process 300, as well as any or all of the individual steps therein, may be performed by any one or more of financial service system 110, seller system 120, or buyer system 130. For exemplary purposes, FIG. 3 is disclosed as being performed by financial service system 110.

Financial service system 110 may receive purchase transaction information over network 140 associated with the unsecured loan account configured for buyer system 130 (Step 310). Alternatively, financial service system 110 may receive the purchase transaction information by postal mail, telephonic means, via a mobile application, or by any other suitable means of communication. Financial service system 110 may receive the purchase transaction information from seller system 120, buyer system 130, or from within data stored in memory 112. The purchase transaction information may include, for example, the item purchased, the purchase price, the date and location of the purchase, and other information that may be used for confirmation and verification purposes. It is understood that this list of information is not limiting and that any information relating to buyer system 130's purchase of an item from seller system 120 may be received in Step 310.

Financial service system 110 may compare the information received in Step 310 to a set of predetermined criteria stored in memory 112 for purposes of determining the eligibility of buyer system 130 for converting from an unsecured loan account to a secured loan account with more favorable loan parameters (Step 320). The comparison may be made automatically, or may be performed manually by an agent of financial service system 110. In one aspect, the predetermined criteria may include a determination of whether buyer system 130 actually bought the item contemplated at the time financial service system 110 configured the unsecured loan account for buyer system 130 in Step 250 of unsecured loan initiation process 200. In another aspect, the predetermined criteria may include a confirmation and verification of the information relating to creditworthiness of buyer system 130 received by financial service system 110 in Steps 220-230 of unsecured loan initiation process 200. In another aspect, the comparison of Step 320 may be made after buyer system 130 has made a set number of payments to the configured unsecured loan account. It is understood that these examples are not limiting and that the predetermined criteria may include any information associated with members of system 100 and the purchase transaction completed between seller system 120 and buyer system 130.

Based on the comparison between the received purchase transaction information and the predetermined criteria, financial service system 110 may determine an eligibility score for buyer system 130 (Step 330). In one aspect, financial service system 110 may calculate the eligibility score for buyer system 130 based on the extent to which buyer system 130 and the purchase transaction information meet or exceed the predetermined criteria of Step 320. Financial service system 110 may use any information associated with members of system environment 100 and the purchase transaction completed between seller system 120 and buyer system 130 to determine the eligibility score.

Financial service system 110 may determine whether the calculated eligibility score for buyer system 130 meets or exceeds a threshold value (Step 340). If the eligibility score meets or exceeds the threshold value (Step 340: YES), the process proceeds to Step 350, If the eligibility score fails to meet or exceed the threshold value (Step 340: NO), the process proceeds to Step 360.

Financial service system 110 may assign new terms to the loan account associated with buyer system 130. For example, financial service system 110 may convert the account from an unsecured loan account to a secured loan account (Step 350). In one aspect, the second set of terms associated with the loan account may be more favorable once converted. These favorable terms may include a lower interest rate, a lower required installment payment on the loan, a forgiveness of a portion of the principal, or any other favorable alteration to the terms of buyer system 130's loan account associated with financial service system 110. In one aspect, the conversion from an unsecured loan product to a secured loan product may further comprise amending the loan agreement to formally include the item purchased in the sales transaction associated with the loan account as the collateral for the loan. In another aspect, financial service system 110 may place a lien on the title to the purchased item to further bolster the security of the loan. In another aspect, financial service system 110 may transmit funds to seller system 120 as a result of the conversion of buyer system 130's loan account from an unsecured loan product to a secured loan product. In one aspect, these funds may comprise a flat fee previously agreed between financial service system 110 and seller system 120. In another aspect, the funds may comprise a percentage of the sales price of the item. In another aspect, the funds may comprise a percentage of the principal of buyer system 130's loan account. In one aspect, financial service system 110 may transmit the funds directly to seller system 120 via wire transfer. In another aspect, the funds may be transferred to seller system 120 via postal mail or other direct delivery service as a check, cashier's check, or money order.

In one embodiment, financial service system 110 may assign a set of terms to buyer system 130's loan account that are more favorable than the original terms, but less favorable than the most favorable terms available. Financial service system 110 may make this determination, for example, if buyer system 130's eligibility score met the set value rather than exceeding it. Financial system 110 may store a tiered structure of loan account terms in memory 112. Financial service system 110 may variably determine which tier of terms in the structure to assign to buyer system 130's loan account upon achievement of various eligibility scores or alternatively by satisfaction of other criteria determined by financial service system 110.

Alternatively, financial service system 110 may maintain the terms originally configured for buyer system 130's loan account, and maintain the account as an unsecured loan product (Step 360). In one aspect, maintaining the loan account as an unsecured loan product may be a temporary decision, and may be revisited (starting loan conversion process 300 anew) pending additional action or submission of information by buyer system 130. In another aspect, the decision to maintain the loan account as an unsecured loan product may be permanent.

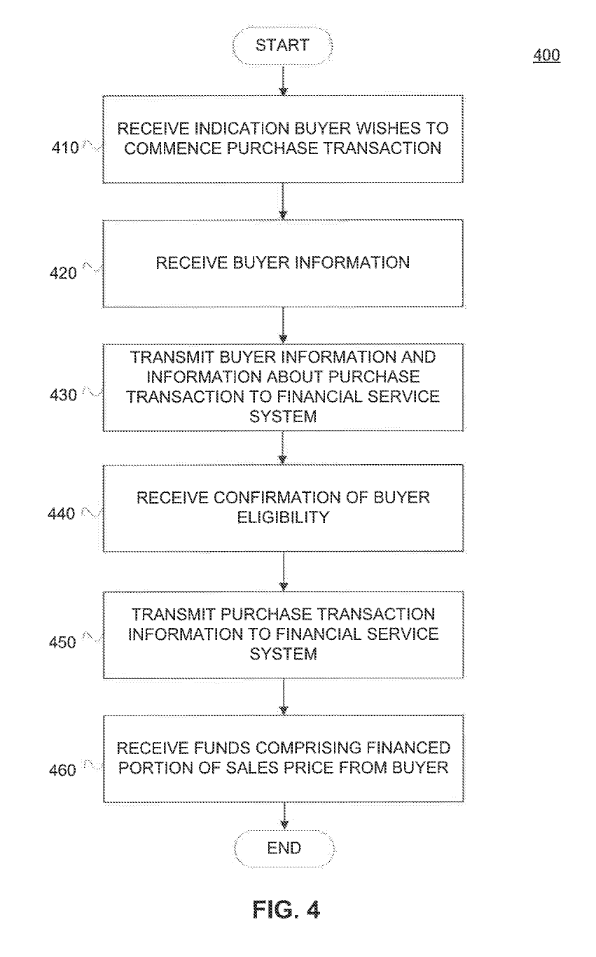

FIG. 4 illustrates an exemplary dealer loan initiation process, consistent with disclosed embodiments. Dealer loan initiation process 400, as well as any or all of the individual steps therein, may be performed by any one or more of financial service system 110, seller system 120, or buyer system 130. For exemplary purposes, FIG. 4 is disclosed as being performed by seller system 120.

Seller system 120 may receive an indication that a buyer wishes to commence a purchase transaction for an item sold by seller system 120 (Step 410). For exemplary purposes, the item may be an automobile and the buyer may be buyer system 130. In one aspect, seller system 120 may receive the indication through a website or other internet portal via network 140 set up for such a purpose. In another aspect, seller system 120 may receive the indication via a mobile application. In another aspect, seller system 120 may receive the indication via an electronic message. In another aspect, seller system 120 may receive the indication in person during a point-of-sale transaction. It is understood that these examples are not intended to be limiting, and that seller system 120 may receive the indication from buyer system 130 via any number of suitable methods of communication.

Seller system 120 may receive information about the user or users associated with buyer system 130 (Step 420). The information gathered may include name, address, social security or other government ID number, credit history, employment information, financial history, information about the item proposed to be purchased, and financial service account information, but this list is not intended to be limiting and any particular encounter may prompt receipt of more or less information.

Seller system 120 may transmit the information received from buyer system 130 to financial service system 110 (Step 430). Seller system 120 may receive confirmation of buyer system 130′s eligibility for the unsecured loan program from financial service system 110 (Step 440). Seller system 120 may transmit purchase transaction information associated with the sale of an item to buyer system 130 to financial service system 110 (Step 450). Seller system 120 may receive funds from financial service system 110 comprising the financed portion of the sales price of the item sold to buyer system 130 (Step 460). In one aspect, seller system 120 may receive the funds into an existing financial service account held by financial service system 110. In another aspect, financial service system 110 may configure a new financial service account for seller system 120, and seller system 120 may receive the funds directly into the new account. In another aspect, the financial service account in which seller system 120 receives the funds may be unaffiliated with financial service system 110. In one aspect, seller system 120 may receive the funds directly from financial service system 110 via wire transfer. In another aspect, seller system 120 may receive the funds from financial service system 110 via postal mail or other direct delivery service as a check, cashier's check, or money order.

In one aspect, seller system 120 may receive the information and communications of dealer loan initiation process 400 in person during a point-of-sale transaction. In another aspect, seller system 120 may receive the information and communications through a website or other internet portal via network 140 set up for such a purpose. In another aspect, seller system 120 may receive the information and communications via a mobile application. In another aspect, seller system 120 may receive the information and communications via an electronic message. It is understood that these examples are not intended to be limiting, and that seller system 120 may receive the information and communications of dealer loan initiation process 400 via any number of well-known methods of communication.

Other features and functionalities of the described embodiments are possible. For example, the processes of FIGS. 2-4 are not limited to the sequences described above. Variations of these sequences, such as the removal and/or the addition of other process steps may be implemented without departing from the spirit and scope of the disclosed embodiments.

Additionally, the disclosed embodiments may be applied to different types of sales between private parties. Any financial institution that provides loan accounts to customers may employ systems, methods, and articles of manufacture consistent with certain principles related to the disclosed embodiments. In addition, any buyer or seller of an item in a private transaction may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

What is claimed is:

1. A system for providing purchase financing, the system comprising:
a memory storing instructions; and
a processor configured to execute the instructions to:
receive an indication that a buyer has requested a loan account, the indication including buyer information;
determine creditworthiness of the buyer based on the buyer information;
configure a loan account according to a first set of terms for the buyer based on the creditworthiness determination;
initiate transmission of funds associated with the loan account to the buyer according to the first set of terms;
receive purchase transaction information associated with a sale item subsequent to the transmission of funds;
determine an eligibility score for a secured loan account associated with the buyer based on the buyer information and received purchase transaction information; and
associate a second set of terms for the loan account based on the determined eligibility score.

2. The system of claim 1, wherein the buyer information comprises one or more of information about an item the buyer seeks to purchase, proof of income, contact information, or information associated with a financial service account.

3. The system of claim 1, wherein the loan account configured according to the first set of terms is an unsecured loan account.

4. The system of claim 1, wherein the first set of terms for the loan account comprises one or more of an interest rate, payment schedule, or approved amount financed based on the creditworthiness determination.

5. The system of claim 1, wherein determining an eligibility score for a secured loan account associated with the buyer comprises performing a comparison of the received purchase transaction information to a set of predetermined criteria,

6. The system of claim 5, wherein the predetermined criteria comprises one or more of the item purchased, verification of creditworthiness, or payment history.

7. The system of claim 1, wherein associating a second set of terms for the loan account based on the determined eligibility score comprises comparing the determined eligibility score to a threshold value.

8. The system of claim 7, wherein associating a second set of terms for the loan account based on the determined eligibility score further comprises converting the account from an unsecured loan account to a secured loan account when the determined eligibility score meets or exceeds the threshold value.

9. The system of claim 7, wherein the second set of terms for the loan account comprises one or more of a lower interest rate, a lower required installment payment on the loan, or a forgiveness of a portion of the loan principal as compared to the first set of terms when the determined eligibility score meets or exceeds the threshold value.

10. The system of claim 9, wherein the difference between the second set of the terms and the first set of terms varies based on the difference between the determined eligibility score and the threshold value.

11. The system of claim 7, wherein the second set of terms for the loan account is equal to the first set of terms for the loan account when the determined eligibility score fails to meet or exceed the threshold value.

12. A method for providing purchase financing, the method comprising:
receiving an indication that a buyer has requested a loan account, the indication including buyer information;
determining, via one or more processors, the creditworthiness of the buyer based on the buyer information;
configuring, via the one or more processors, a loan account according to a first set of terms for the buyer based on the e creditworthiness determination;
initiating transmission of funds to the buyer according to the first set of terms;
receiving purchase transaction information associated with a sale of an item purchased by the buyer subsequent to the transmission of funds;
determining an eligibility score for a secured loan account associated with the buyer based on the buyer information and received purchase transaction information; and
associating, via the one or more processors, a second set of terms for the loan account based on the determined eligibility score.

13. The method of claim 12, wherein the loan account configured according to the first set of terms is an unsecured loan account.

14. The method of claim 12, wherein determining an eligibility score for a secured loan account associated with the buyer comprises performing a comparison of the received purchase transaction information to a set of predetermined criteria.

15. The method of claim 14, wherein the predetermined criteria comprises one or more of the item purchased, verification of creditworthiness, or payment history.

16. The method of claim 12, wherein associating a second set of terms for the loan account based on the determined eligibility score comprises comparing the determined eligibility score to a threshold value.

17. The method of claim 16, wherein associating a second set of terms for the loan account based on the determined eligibility score further comprises converting the account from an unsecured loan account to a secured loan account when the determined eligibility score exceeds the threshold value.

18. The method of claim 16, wherein the second set of terms for the loan account comprises one or more of a lower interest rate, a lower required installment payment on the loan, or a forgiveness of a portion of the loan principal as compared to the first set of terms.

19. The method of claim 18, wherein the difference between the second set of the terms and the first set of terms varies based on the difference between the determined eligibility score and the threshold value.

20. A system for providing purchase financing, the system comprising:
a memory storing instructions; and
a processor configured to execute the instructions to:
receive an indication that a buyer wishes to commence a purchase transaction, the indication including buyer information;
transmit information associated with one or more of the buyer or the purchase transaction to a financial service system;
receive confirmation of buyer financing eligibility for an unsecured loan account associated with the purchase transaction from the financial service system;
transmit purchase transaction information associated with the sale of a buyer item to the financial service system; and
receive funds associated with the unsecured loan account comprising the financed portion of the sales price from the buyer, wherein the funds were transmitted to a financial service account associated with the buyer by the financial service system.
